(19) United States
(12) Patent Application Publication
(10) Pub. No.: US 2010/0125689 A1
(43) Pub. Date: May 20, 2010

(54) ELECTRONIC APPARATUS CAPABLE OF RECEIVING DIFFERENT TYPES OF MEMORY CARDS

(75) Inventors: Cheng Liang Chang, Taipei County (TW); Tzu-Shiun Liu, Hsinchu County (TW); Mao-Lin Wu, Hsinchu County (TW); Wen Hua Wu, Yilan County (TW); Shih-Hung Lin, Hsinchu City (TW); You-Kuo Lin, Tainan City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/274,524

(22) Filed: Nov. 20, 2008

(51) Int. Cl. G06F 13/00

(52) U.S. Cl. 710/301

(57) ABSTRACT

The invention provides an electronic apparatus capable of receiving a first-type memory card or a second-type memory card. In one embodiment, the electronic apparatus comprises a socket, a controller circuit, and an interface circuit. The socket is coupled to the first-type memory card through a set of first pins and is coupled to the second-type memory card with a set of second pins. The controller circuit accesses the first-type memory card or the second-type memory card via a plurality of input/output (IO) pins, and determines which of the first-type memory card and the second-type memory card is inserted into the socket according to the voltage of a target IO pin selected from the IO pins. The interface circuit sets the voltage of the target pin to different values according to whether the first-type memory card or the second-type memory card is inserted into the socket.

### BACKGROUND OF THE INVENTION

1. Field of the Invention

The invention relates to memory cards, and more particularly to memory stick cards and secure digital cards.

2. Description of the Related Art

Flash memory cards can store large amounts of data without the requirement of an external power supply to maintain the data. In addition, flash memory cards meet size requirements of portable devices due to its smaller size. Flash memory cards are therefore popular with manufactures of digital portable devices such as digital cameras, handheld computers, mobile telephones, music players, and portable memory drives.

Although there are several types of flash memory cards which are fabricated, the memory stick (MS) cards and secure digital (SD) cards are currently the most popular. Meanwhile, some electronic devices storing data with flash memory cards, are capable of accessing more than one type of memory card for user convenience. In addition, a card reader must access different types of memory cards for a host device. The electronic devices capable of accessing different types of memory cards must therefore, first identify the type of the memory card, before the memory cards are accessed.

Referring to FIG. 2, a block diagram of a portion of a conventional electronic apparatus 200 accessing different types of memory cards are shown. The electronic apparatus 200 comprises a memory card 202, a socket 204, an interface circuit 206, and a controller IC 208. The memory card 202 is inserted into the socket 204 to be accessed by the controller IC 208. When the memory card is inserted into a slot of the socket 204, a plurality of pins of the socket 204 are coupled to the memory card 202 to receive different signals exchanged between the memory card 202 and the controller IC 208. The memory card 202 may be a secure digital card or a memory stick card.

Referring to FIG. 1A, a table listing multiple signals exchanged between a secure digital card 202 and the controller IC 208 is shown. The multiple signals include a clock signal SD_CLK, a command signal SD_CMD, and four data signals SD_D0, SD_D1, SD_D2, and SD_D3. While the clock signal SD_CLK is only sent from the controller IC 208 to the secure digital card 202, data of the other signals SD_CMD, SD_D0, SD_D1, SD_D2, and SD_D3 are exchanged in both directions.

Referring to FIG. 1B, a table listing multiple signals exchanged between a memory stick card 202 and the controller IC 208 is shown. The multiple signals include a clock signal MS_CLK, a bus state signal MS_BS, and four data signals MS_D0, MS_D1, MS_D2, and MS_D3. While the clock signal MS_CLK and MS_BS are only sent from the controller IC 208 to the memory stick card 202, data of the other signals MS_D0, MS_D1, MS_D2, and MS_D3 are exchanged in both directions.

After the socket 204 receives the signals with multiple pins, the signals must be transferred to a plurality of input/output (IO) pins of the controller IC 208. The interface circuit 206 couples the pins of the socket 204 to the IO pins of the controller IC 208 with a plurality of signal lines, thus enabling the signals to be exchanged between the memory card 202 and the controller IC 208. In addition, the voltages of the pins of the socket 204 must be kept at predetermined initial values before signals are exchanged between the memory card 202 and the controller IC 208 through the pins. If the memory card 202 is a memory stick card, the memory stick card lowers the voltages of the pins to an initial voltage of a ground level when the memory stick card 202 is inserted into the socket 204. If the memory card 202 is a secure digital card, the interface circuit 206 raises the voltages of the pins to an initial voltage of a high level when the secure digital card 202 is inserted into the socket 204.

Referring to FIG. 3A, a block diagram of a portion of a conventional interface circuit 300 of the electronic apparatus 200 of FIG. 2 is shown. The socket 204 receives signals listed in the table of FIG. 1B from a memory stick card 202 with corresponding pins MS_CLK, MS_BS, MS_D0, MS_D1, MS_D2, and MS_D3. The socket 204 also receives signals listed in the table of FIG. 1A from a secure digital card 202 with corresponding pins SD_CLK, SD_CMD, SD_D0, SD_D1, SD_D2, and SD_D3. The controller IC 208 receives signals from the memory card 202 with a plurality of IO pins IC_IOₐ, IC_IO_{b}, IC_IO_{c}, IC_IO_{d}, IC_IOₑ, and IC_IO_{f}.

The interface circuit 300 couples each of the IO pins of the controller IC 208 to one of the pins receiving a signal from the MS card and one of the pins receiving a signal from the SD card to reduce the required number of IO pins. For example, the MS_BS pin and the SD_CMD pin are coupled to the IC_IOₐ pin, the MS_CLK pin and the SD_CLK pin are coupled to the IC_IO_{b} pin, and the MS_D0 pin and the SD_D0 pin are coupled to the IC_IO_{c} pin.

Two card insertion pins SD_INS and MS_INS of the socket 204 are used to respectively detect insertion of the secure digital card and the memory stick card. When the secure digital card or the memory stick card is inserted into the slot of the socket 204, one of the voltages of the corresponding card insertion pins SD_INS and MS_INS is lowered to the ground. The interface circuit 300 comprises two modules 302 and 304 setting the voltages of the pins of the socket 204 to predetermined initial voltages. When a secure digital card is inserted, the voltage of the pin SD_INS is lowered to ground to turn on the transistor 312, thereby raising the voltage of the node 306 to a high level V_{DD}, wherein the node 306 is coupled to the pins of the socket 204. When a memory stick card is inserted, the voltage of the pin MS_INS is lowered to ground to turn on the transistors 314 and 316, thereby lowering the voltage of the node 308 to ground V_{GND}, wherein the node 308 is coupled to the pins of the socket 204.

Referring to FIG. 3B, another portion 350 of the conventional interface circuit 300 of the electronic apparatus 200 of FIG. 2 is shown. The circuit portion 350 comprises two diodes 352 and 354. When the voltages of any one of the card insertion pins MS_INS and SD_INS are lowered, one of the diodes 352 and 354 is turned on, thereby lowering the voltage of a card detection pin IC_CD of the controller IC 208. Referring to FIG. 4, a flowchart of a method 400 for card detection for the controller IC 208 is shown. The controller IC 208 first detects the voltage of the card detection pin IC_CD (step 402). If the voltage of the card detection pin IC_CD is at a low level (step 404), the controller IC 208 first sends SD card detecting commands to the memory card 202 to detect whether the memory card 202 is a secure digital card (step 406). If the memory card 202 is not a secure digital card (step 408), the controller IC 208 then sends MS card detecting commands to the memory card 202 to detect whether the memory card 202 is a memory stick card (step 410).

The interface circuit 300, however, cannot directly determine whether the memory card 202 inserted into the socket 204 is a memory stick card or a secure digital card according to the voltage of the card detection pin IO_CD. The controller IC 208 therefore must send MS card detecting commands and SD card detecting commands in turns to determine the type of the memory card 202. When a secure digital card 202 receives MS card detecting commands, the secure digital card may be confused by the MS card detecting commands, resulting in an error state for the secure digital card. When a MS card receives SD card detection commands, the MS card may be confused by the SD card detecting commands. In addition, the controller IC 208 requires an extra pin IO_CD for card detection, increasing the required number of IO pins of the controller IC 208, thus increasing hardware costs. A novel interface circuit for coupling the socket 204 and the controller IC 208 is therefore required.

### BRIEF SUMMARY OF THE INVENTION

The invention provides an electronic apparatus capable of receiving a first-type memory card or a second-type memory card. In one embodiment, the electronic apparatus comprises a socket, a controller circuit, and an interface circuit. The socket is coupled to the first-type memory card through a set of first pins and is coupled to the second-type memory card with a set of second pins. The controller circuit accesses the first-type memory card or the second-type memory card via a plurality of input/output (IO) pins, and determines which of the first-type memory card and the second-type memory card is inserted into the socket according to the voltage of a target IO pin selected from the IO pins. The interface circuit coupled between the socket and the controller circuit has a plurality of signal lines connecting one of the IO pins to one of the first pins and one of the second pins and sets the voltage of the target pin to different values according to whether the first-type memory card or the second-type memory card is inserted into the socket.

The invention also provides an interface circuit, coupled between a socket and a controller circuit. In one embodiment, the socket is coupled to the memory stick card with a set of first pins when the memory stick card is inserted therein and is coupled to the secure digital card with a set of second pins when the secure digital card is inserted therein. The interface circuit comprises a plurality of signal lines and a card identification circuit. The signal lines connects one of a plurality of input/output (IO) pins of the controller circuit to one of the first pins and one of the second pins. The card identification circuit sets the voltage of a target signal line selected from the signal lines to different values according to whether the memory stick card or the secure digital card is inserted into the socket to enable the controller circuit to determine which of the memory stick card and the secure digital card is inserted into the socket according to the voltage of the IO pin coupled to the target signal line.

The invention also provides a method of accessing a first-type memory card and a second-type memory card. First, a socket capable of accepting the first-type memory card with a set of first pins or accepting the second-type memory card with a set of second pins is provided, wherein the socket lowers the voltage of a first-type card insertion pin when the first-type memory card exists in the socket. A controller circuit accessing the first-type memory card or the second-type memory card via a plurality of input/output (IO) pins provided. An interface circuit is then deployed between the controller circuit and the socket, wherein the interface circuit couples one of the IO pins to one of the first pins and one of the second pins, and raises the voltage of a signal line coupling to one of the IO pins when the voltage of the first-type card insertion pin is lowered to enable the controller circuit to determine which of the first-type memory card and the second-type memory card is inserted into the socket according to the voltage of the IO pin coupled to the signal line.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A shows a table listing multiple signals exchanged between a secure digital card and a controller IC;

FIG. 1B shows a table listing multiple signals exchanged between a memory sick card and a controller IC;

FIG. 2 is a block diagram of a portion of a conventional electronic apparatus accessing different types of memory cards;

FIG. 3A is a block diagram of a portion of a conventional interface circuit of the electronic apparatus of FIG. 2;

FIG. 3B shows another portion of the conventional interface circuit of the electronic apparatus of FIG. 2;

FIG. 4 is a flowchart of a conventional method for card detection for the controller IC;

FIG. 5 is a block diagram of an electronic apparatus capable of receiving more than one type of memory card according to the invention;

FIG. 6A shows an embodiment of an SD card interface circuit according to the invention;

FIG. 6B shows an embodiment of an MS card interface circuit according to the invention;

FIG. 7A shows an embodiment of the controller IC coupling circuit according to the invention;

FIG. 7B shows an embodiment of a card identification circuit corresponding to the controller IC coupling circuit of FIG. 7A according to the invention;

FIG. 8A shows another embodiment of a controller IC coupling circuit according to the invention;

FIG. 8B shows an embodiment of a card identification circuit corresponding to the controller IC coupling circuit of FIG. 8A according to the invention;

FIG. 9 shows an embodiment of a card identification circuit according to the invention; and

FIG. 10 is a flowchart of a method for identifying the type of a memory card for the controller IC according to the invention.

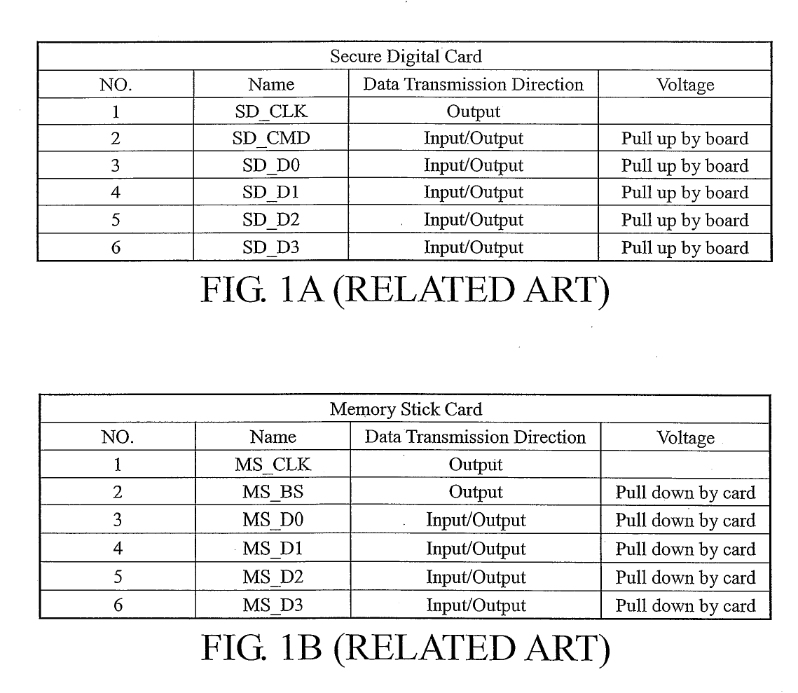

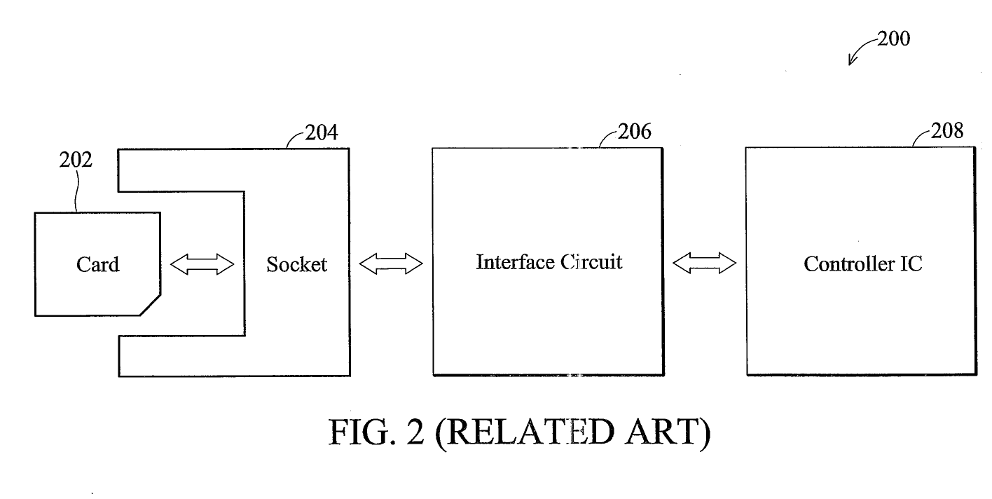

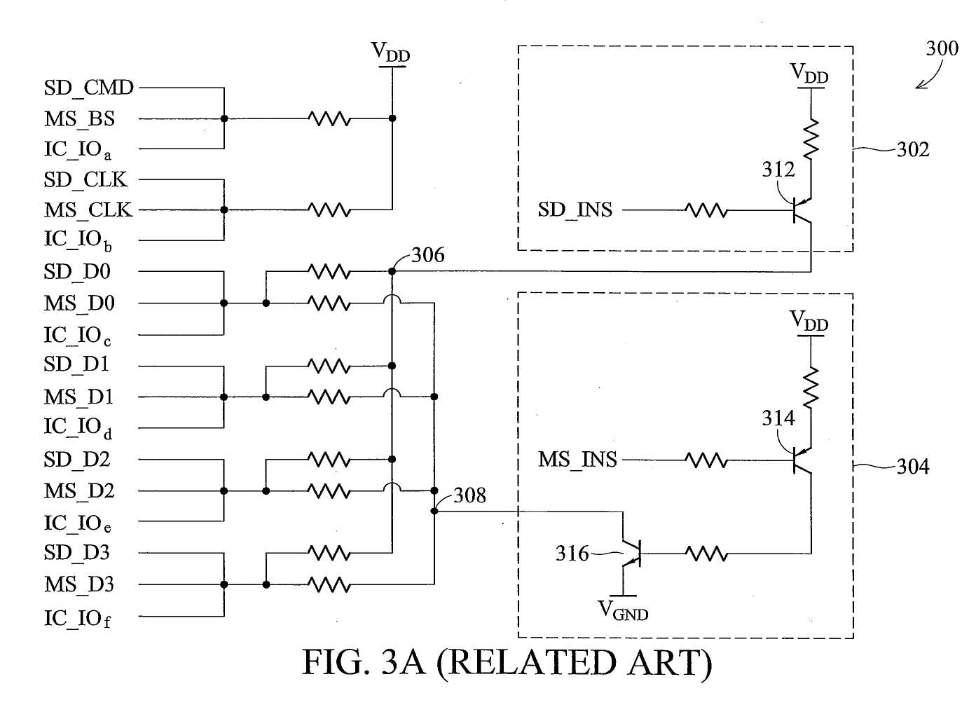

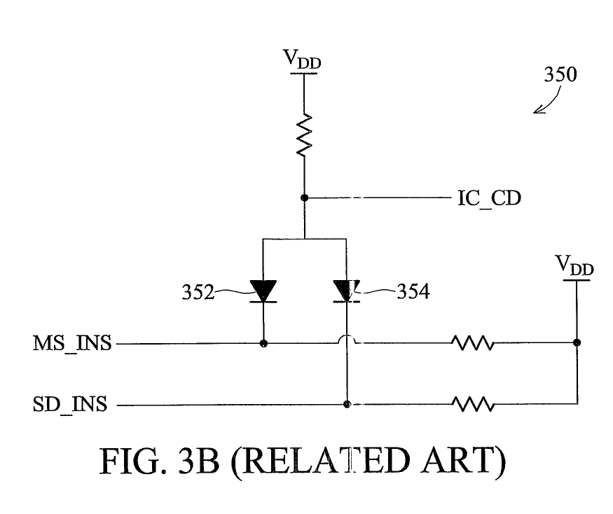

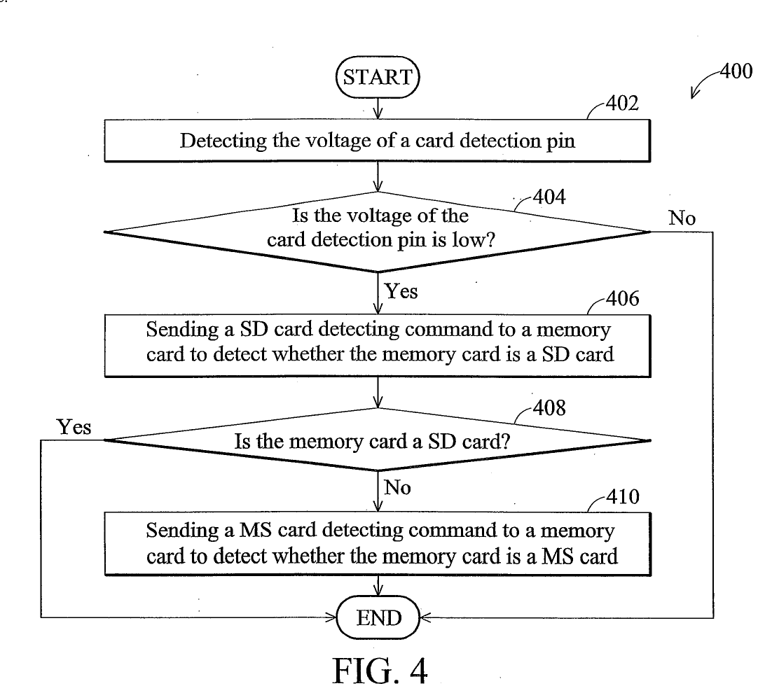

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

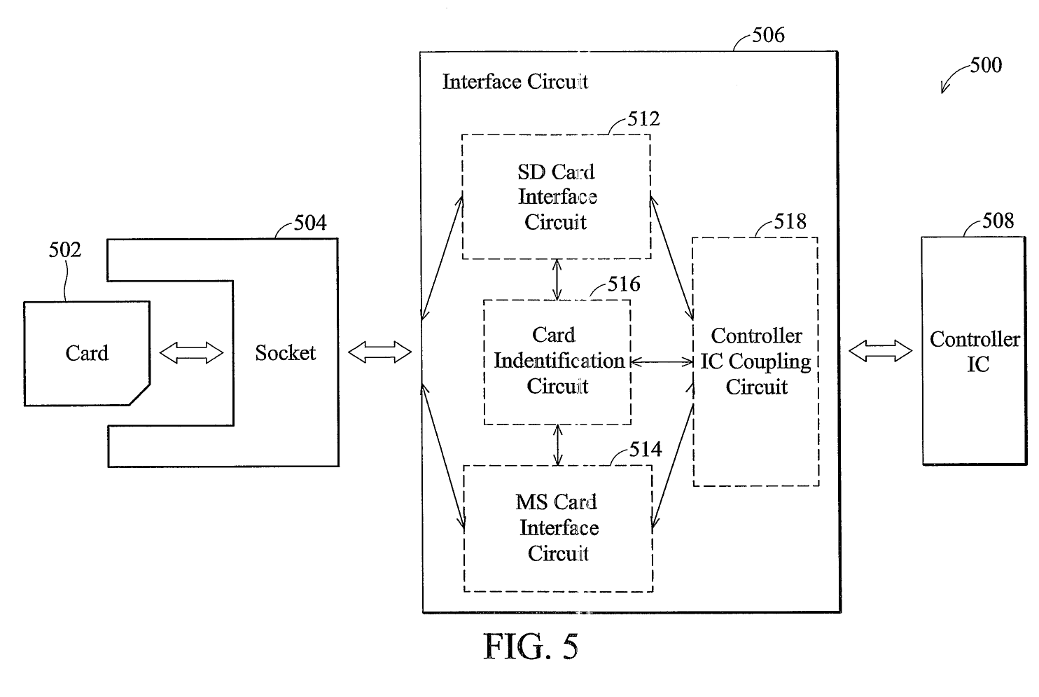

Referring to FIG. 5, a block diagram of an electronic apparatus 500 capable of receiving more than one type of memory card according to the invention is shown. The electronic apparatus 500 comprises a socket 504, an interface circuit 506, and a controller IC 508. A memory card 502 is inserted into the socket 504 to be accessed by the controller IC 508. In one embodiment, the memory card 502 may be a memory stick (MS) card or a secure digital (SD) card. When the memory card 502 inserted into the socket 504 is a memory stick card, the socket 504 is coupled to the memory card 502 with a set of first pins including a clock pin MS_CLK, a bus state pin MS_BS, and four data pins MS_D0˜MS_D3. When the memory card 502 inserted into the socket 504 is a secure digital card, the socket 504 is coupled to the memory card 502 with a set of second pins including a clock pin SD_CLK, a command pin SD_CMD, and four data pins SD_D0˜SD_D3. In addition, the socket 504 lowers the voltage of an MS card insertion pin MS_INS when a memory stick card 502 is inserted therein, and the socket 504 lowers the voltage of an SD card insertion pin SD-INS when a secure digital card 502 is inserted therein.

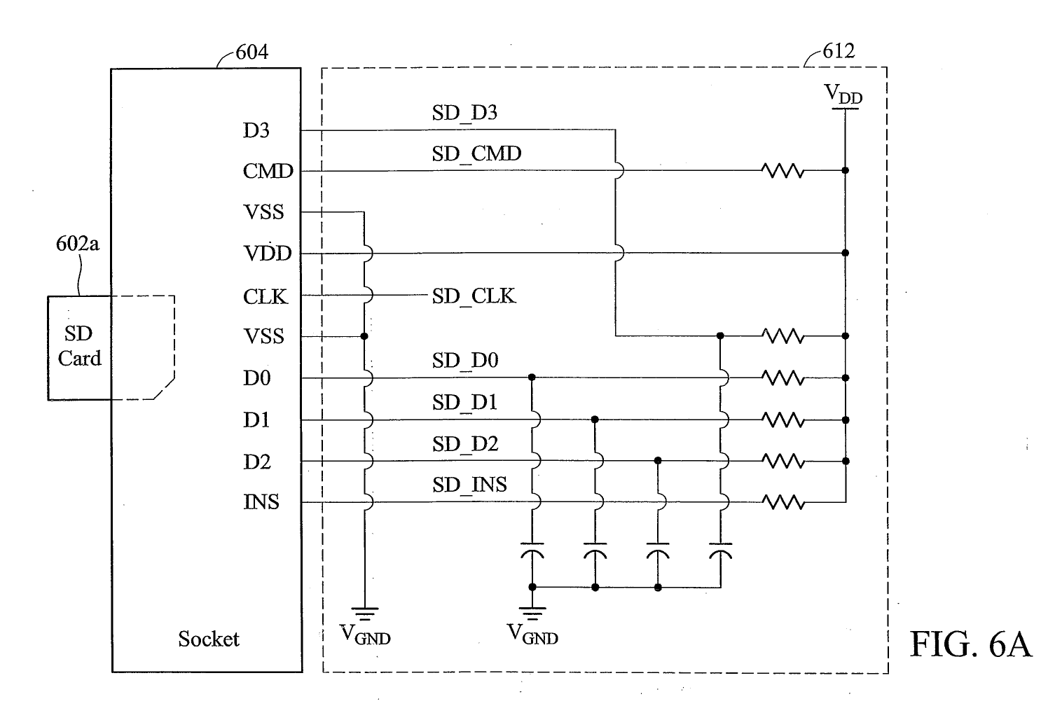

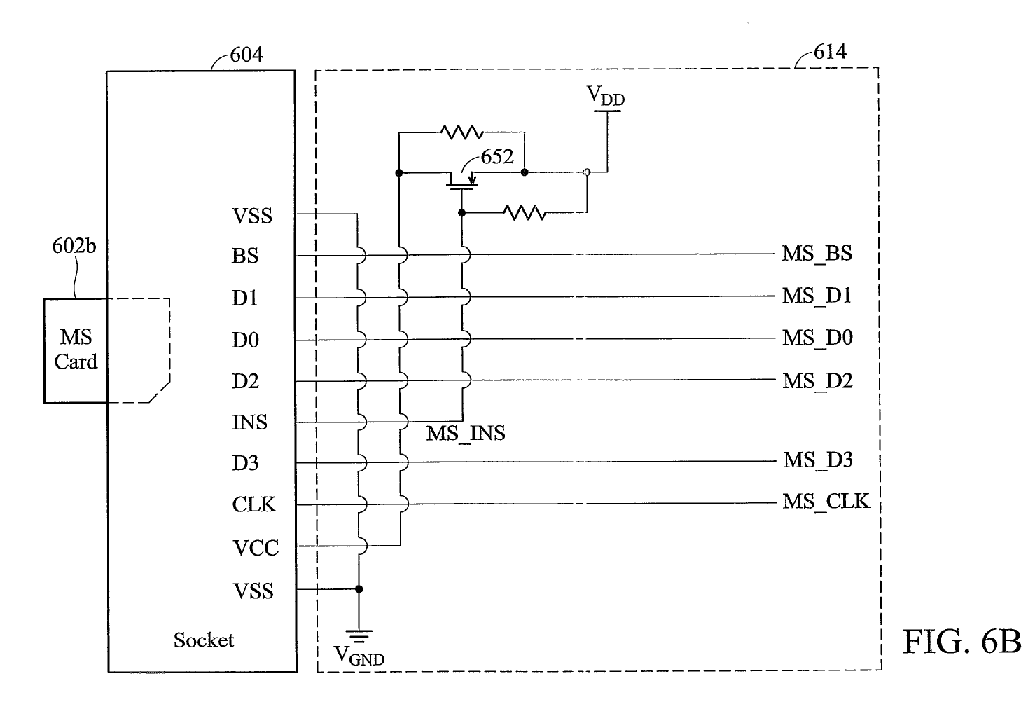

The interface circuit 506 comprises an SD card interface circuit 512, an MS card interface circuit 514, a card identification circuit 516, and a controller IC coupling circuit 518. The SD card interface circuit 512 comprises a plurality of signal lines respectively coupled to the second pins. Referring to FIG. 6A, an embodiment of an SD card interface circuit 612 according to the invention is shown. A secure digital card 602a is inserted into the socket 604, and a plurality of signal lines of the SD card interface circuit 612 is coupled to the second pins of the socket 604 for transmitting signals SD_CLK, SD_CMD, SD_INS, and SD_DO SD_D3. In addition, the SD card interface circuit 612 raises the voltages of the second pins to an initial voltage of a high level V_{DD} when the secure digital card 602a is inserted into the socket 604.

The MS card interface circuit 514 also comprises a plurality of signal lines respectively coupled to the first pins. Referring to FIG. 6B, an embodiment of an MS card interface circuit 614 according to the invention is shown. A memory stick card 602b is inserted into the socket 604, and a plurality of signal lines of the MS card interface circuit 614 is coupled to the first pins of the socket 604 for transmitting signals MS_CLK, MS_BS, MS_INS, and MS_D0˜MS_D3. When the memory stick card 602b is inserted into the socket 504, the memory stick card 602b automatically lowers the voltages of the first pins to an initial voltage of a ground level.

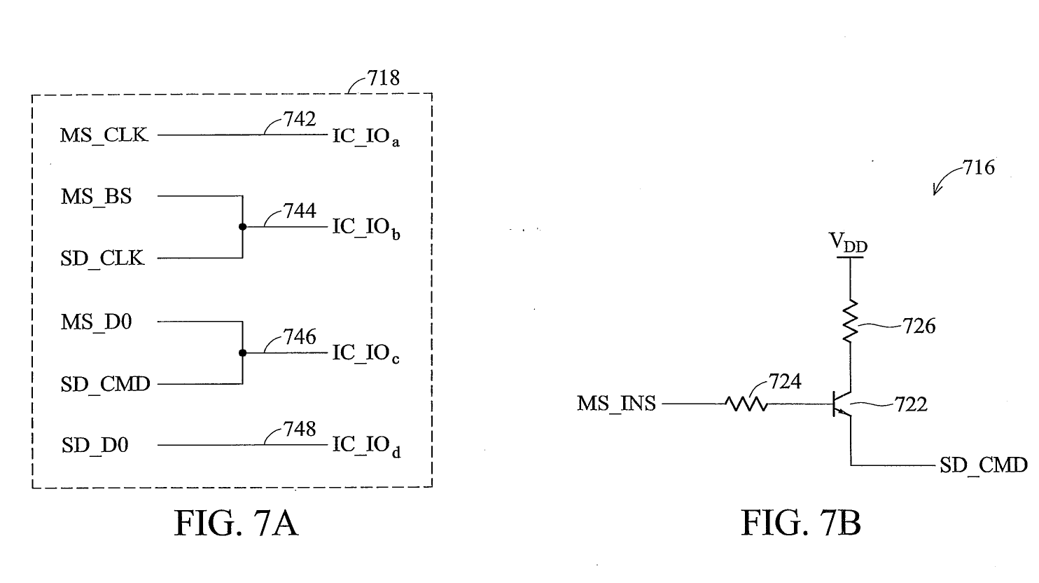

The controller IC 508 accesses the memory card 502 via a plurality of input/output (IO) pins. The controller IC coupling circuit 518 then connects the IO pins of the controller IC 508 to the signal lines of the SD card interface circuit 512 and the MS card interface circuit 514 to exchange signals therebetween. Referring to FIG. 7A, an embodiment of the controller IC coupling circuit 718 according to the invention is shown. The controller IC coupling circuit 718 comprises four signal lines 742, 744, 746, and 748. The signal line 742 couples an input/output (IO) pin IC_IOₐ of the controller IC 508 to the MS_CLK pin of the socket 504. The signal line 744 couples an IO pin IC_IO_{b} of the controller IC 508 to the SD_CLK pin and the MS_BS pin of the socket 504. The signal line 746 couples an IO pin IC_IO_{c} of the controller IC 508 to the SD_CMD pin and the MS_D0 pin of the socket 504. The signal line 748 couples an IO pin IC_IO_{d} of the controller IC 508 to the SD_D0 pin of the socket 504.

Before the controller IC 508 starts to access the memory card 502, the controller IC 508 must identify the type of the memory card 502. Assume that the controller IC 508 determines whether a memory stick card 502 or a secure digital card 502 is inserted into the socket 504 according to the voltage of the pin IC_IO_{c}. The card identification circuit 516 then sets the voltage of signal line 746 coupled to the pin IC_IO_{c} to different values according to whether a memory stick card or a secure digital card is inserted into the socket, thus enabling the controller IC 508 to determine whether the memory stick card or the secure digital card is inserted into the socket 504 according to the voltage of the pin IC_IO_{c}.

Referring to FIG. 7B, an embodiment of a card identification circuit 716 corresponding to the controller IC coupling circuit 718 of FIG. 7A according to the invention is shown. The card identification circuit 716 comprises a BJT transistor 722 having a base coupled to the MS card insertion pin MS_INS, a collector coupled to the high voltage source V_{DD}, and an emitter coupled to the signal line 746 which is coupled to the pins MS_D0 and SD_CMD of the socket 502. When a memory stick card 502 is inserted into the socket 504, the socket 504 lowers the voltage of the MS card insertion pin MS_INS to a ground level to turn off the BJT transistor 722. Because the memory stick card 502 automatically lowers voltages of all first pins including the pin MS_D0 to ground, and the pin SD_CMD is floating due to nonexistence of a secure digital card, the voltage of the signal line 746 is lowered to ground with that of the pin MS_D0. The voltage of the pin IC_IO_{c} is therefore lowered to ground, informing the controller IC 508 that a memory stick card is inserted into the socket 504.

When a secure digital card 502 is inserted into the socket 504, the voltage of the MS card insertion pin MS_INS is at a high level, turning on the BJT transistor 722. When the BJT transistor 722 is turned on, the voltage of the signal line 746 at the emitter of the BJT 722 is raised to the high voltage V_{DD} at the collector of the BJT 722. Because the memory stick card 502 does not exist, the pin MS_D0 is floating, and the voltage of the signal line 746 is raised to the high level V_{DD}. The voltage of the pin IC_IO_{c} is therefore raised to the high level V_{DD}, informing the controller IC 508 that a secure digital card is inserted into the socket 504. Thus, the controller IC 508 can determine the type of the memory card 502 inserted into the socket 504 according to the voltage of the pin IC_IO_{c}.

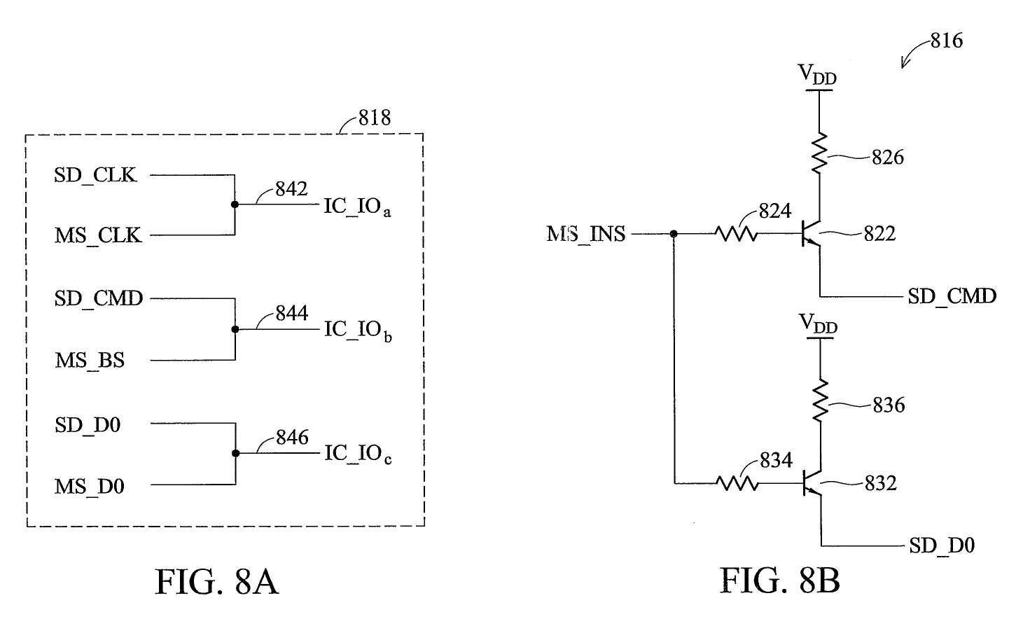

Referring to FIG. 8A, another embodiment of a controller IC coupling circuit 818 according to the invention is shown. The controller IC coupling circuit 818 comprises three signal lines 842, 844, and 846. The signal line 842 couples an input/output (IO) pin IC_IOₐ of the controller IC 508 to the SD_CLK pin and the MS_CLK pin of the socket 504. The signal line 844 couples an IO pin IC_IO_{b} of the controller IC 508 to the SD_CMD pin and the MS_BS pin of the socket 504. The signal line 846 couples an IO pin IC_IO_{c} of the controller IC 508 to the SD_D0 pin and the MS_D0 pin of the socket 504.

Referring to FIG. 8B, an embodiment of a card identification circuit 816 corresponding to the controller IC coupling circuit 818 of FIG. 8A according to the invention is shown. The card identification circuit 816 comprises two BJT transistors 822 and 832, respectively having a base coupled to the MS card insertion pin MS_INS, and a collector coupled to the high voltage source V_{DD}. The emitter of the transistor 822 is coupled to the signal line 844 which is coupled to the pins MS_BS and SD_CMD of the socket 502, and the emitter of the transistor 832 is coupled to the signal line 846 which is coupled to the pins MS_D0 and SD_D0 of the socket 502. Both the BJT transistors 822 and 832 functions similarly as the BJT transistor 722 of FIG. 7B. The voltages of the pins IC_IO_{b} and IC_IO_{c} are therefore raised to the high level V_{DD} when a secure digital card is inserted into the socket 504 and lowered to ground V_{GND} when a memory stick card is inserted into the socket 504. Thus, the controller IC 508 can determine the type of the memory card 502 inserted into the socket 504 according to the voltage of the pin IC_IO_{c} or the pin IC_IO_{b}.

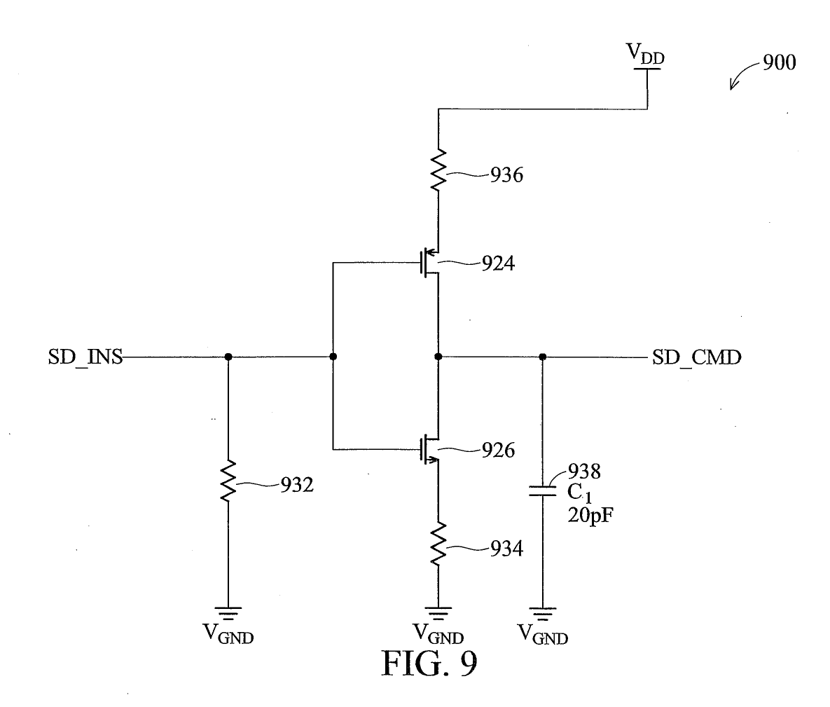

The card identification circuits 716 and 816 is triggered by the voltage of the MS card insertion pin MS_INS. A card identification circuit can also be triggered by the voltage of the SD card insertion pin SD_INS. Referring to FIG. 9, an embodiment of a card identification circuit 900 according to the invention is shown. The card identification circuit 900 comprises a PMOS transistor 924, a NMOS transistors 926, and a capacitor 938. When a secure digital card is inserted into the socket 504, the socket 504 lowers the voltage of the SD card insertion pin SD_INS to ground, turning on the PMOS transistor 924. The voltage at the drain of the PMOS transistor 924 is therefore raised to a high level V_{DD} to inform the controller IC 508 that a secure digital card is inserted into the socket 504.

When a memory stick card is inserted into the socket 504, the voltage of the SD card insertion pin SD_INS is at a high level, turning on the NMOS transistor 926, and the voltage at the drain of the NMOS transistor 926 is therefore lowered to ground V_{GND} to inform the controller IC 508 that a memory stick card is inserted into the socket 504. The signal line coupled to the drain of the NMOS transistor 926 may be the signal line 844 of FIG. 8A or the signal line 746 of FIG. 7A.

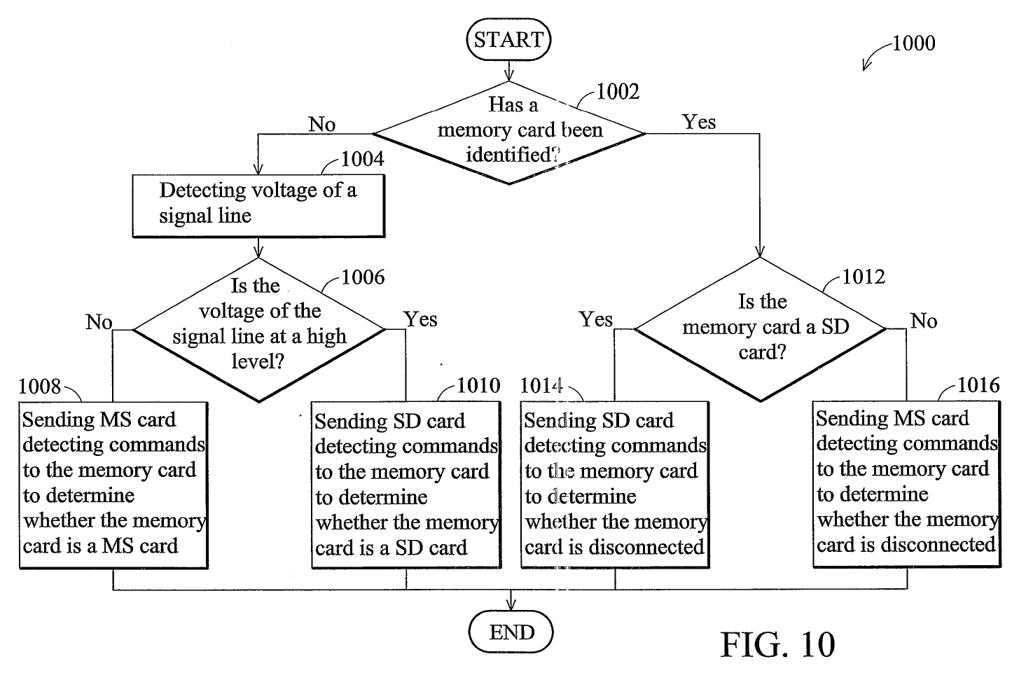

Referring to FIG. 10, a flowchart of a method 1000 for identifying the type of a memory card 502 for the controller IC 508 according to the invention is shown. The controller IC 508 first determines whether the type of the memory card 502 has been identified (step 1002). If not, the memory card 502 may be just inserted into the socket 504. The controller IC 508 then detects voltage of a signal line which may be the pin IC_IO_{c} of FIG. 7A or the pins IC_IO_{b} and IC_IO_{c} of FIG. 8A (step 1004). If the voltage of the signal line is at a low level (step 1006), the memory card 502 is a memory stick card, and the controller IC 508 sends MS card detecting commands to the memory card 502 to verify that the memory card 502 is a MS card (step 1008). If the voltage of the signal line is at a high level (step 1006), the memory card 502 is a secure digital card, and the controller IC 508 sends SD card detecting commands to the memory card 502 to verify that the memory card 502 is a SD card (step 1010). Thus, a secure digital card 502 won't receive MS card detecting commands, and no errors are induced in the secure digital card. A MS card 502 won't receive SD card detecting commands, and no errors are induced in the MS card.

If the type of the memory card 502 has been identified (step 1002), the memory card 502 may be disconnected. If the memory card 502 has been identified as a SD card (1012), the controller IC 508 sends SD card detecting commands to the memory card 502 to determine whether the memory card 502 is disconnected (step 1014). If the memory card 502 has been identified as a MS card (1012), the controller IC 508 sends MS card detecting commands to the memory card 502 to determine whether the memory card 502 is disconnected (step 1016).

The invention provides an interface circuit identifying the type of a memory card. After a type of a memory card is identified, the interface circuit raises or lowers the voltage of an IO pin of a controller IC according to the type of the memory card. Thus, the controller IC can identify the type of the memory card in advance before card detecting commands are sent to the memory card, and no errors are induced. In addition, the IO pin for identifying the type of the memory card is an IO pin for transmitting signals between the memory card and the controller IC, thus reducing the number of pins required of the controller IC and reducing hardware costs.

In the above examples, MS card and SD card are recited for MS interface and SD interface respectively. It is known that MS interface may also support MS Pro card and SD interface may also support MMC card. Therefore, the inventive concept as disclosed above may also be applied on MS Pro card and MMC card.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic apparatus capable of receiving a first-type memory card or a second-type memory card, comprising:
a socket, coupled to the first-type memory card through a set of first pins, and coupled to the second-type memory card with a set of second pins;
a controller circuit, accessing the first-type memory card or the second-type memory card via a plurality of input/output (IO) pins, and determining which of the first-type memory card and the second-type memory card is inserted into the socket according to the voltage of a target IO pin selected from the IO pins; and
an interface circuit, coupled between the socket and the controller circuit, having a plurality of signal lines connecting one of the IO pins to one of the first pins and one of the second pins, and setting the voltage of the target pin to different values according to whether the first-type memory card or the second-type memory card is inserted into the socket.

2. The electronic apparatus as claimed in claim 1, wherein the first-type memory card is a memory stick (MS) card, and the second-type memory card is a secure digital (SD) card.

3. The electronic apparatus as claimed in claim 1, wherein the socket can receive only one of the first type memory card and the second type memory card at the same time, the interface circuit raises the voltages of the second pins when the second type memory card is inserted into the socket, and the first-type memory card automatically lowers voltages of the first pins when the first type memory card is inserted into the socket.

4. The electronic apparatus as claimed in claim 2, wherein the first pins comprise at least one data pin, a bus state pin and a clock pin, and the second pins comprise at least one data pin, a command pin and a clock pin.

5. The electronic apparatus as claimed in claim 1, wherein the socket lowers the voltage of a first-type card insertion pin when the first-type memory card is inserted therein, and the socket lowers the voltage of a second-type card insertion pin when the second-type memory card is inserted therein.

6. The electronic apparatus as claimed in claim 5, wherein the interface circuit comprises:
a target signal line which is the signal line coupled to the target IO pin; and
a BJT transistor, having a base coupled to the first-type card insertion pin, a collector coupled to a high voltage source, and an emitter coupled to the target signal line.

7. The electronic apparatus as claimed in claim 6, wherein the target signal line is coupled to a data pin selected from the first pins and a command pin selected from the second pins.

8. The electronic apparatus as claimed in claim 6, wherein the target signal line is coupled to a bus state pin of the first pins and a command pin of the second pins or the target signal line is coupled to a data pin of the first pins and a data pin of the second pins.

9. The electronic apparatus as claimed in claim 5, wherein the card identification circuit comprises:
a target signal line which is the signal line coupled to the target IO pin;
a PMOS transistor, having a gate coupled to the second-type card insertion pin, and a source coupled to a voltage source;
a NMOS transistor, having a gate coupled to the second-type card insertion pin, a source coupled to a ground, and a drain coupled to the drain of the PMOS transistor; and
a capacitor, coupled between the drain of the NMOS transistor and the ground.

10. The electronic apparatus as claimed in claim 9, wherein the target signal line is coupled to a data pin selected from the first pins and a command pin selected from the second pins.

11. The electronic apparatus as claimed in claim 9, wherein the target signal line is coupled to a bus state pin of the first pins and a command pin of the second pins or the target signal line is coupled to a data pin of the first pins and a data pin of the second pins.

12. The electronic apparatus as claimed in claim 1, wherein the controller circuit determines that the second-type memory card is inserted into the socket when the voltage of the signal line is high, and determines that the first-type memory card is inserted into the socket when the voltage of the signal line is low.

13. The electronic apparatus as claimed in claim 1, wherein the electronic apparatus is a memory card reader.

14. An interface circuit, coupled between a socket and a controller circuit, wherein the socket is coupled to the memory stick card with a set of first pins when the memory stick card is inserted therein and is coupled to the secure digital card with a set of second pins when the secure digital card is inserted therein, and the interface circuit comprising:
a plurality of signal lines, connecting one of a plurality of input/output (IO) pins of the controller circuit to one of the first pins and one of the second pins; and
a card identification circuit, setting the voltage of a target signal line selected from the signal lines to different values according to whether the memory stick card or the secure digital card is inserted into the socket to enable the controller circuit to determine which of the memory stick card and the secure digital card is inserted into the socket according to the voltage of the IO pin coupled to the target signal line.

15. The interface circuit as claimed in claim 14, wherein the memory stick card automatically lowers voltages of the first pins when the memory stick card is inserted into the socket, and the interface circuit raises the voltages of the second pins when the secure digital card is inserted into the socket.

16. The interface circuit as claimed in claim 14, wherein the socket lowers the voltage of an MS card insertion pin when the memory stick card is inserted therein, and the socket lowers the voltage of an SD card insertion pin when the secure digital card is inserted therein.

17. The interface circuit as claimed in claim 16, wherein the card identification circuit comprises a BJT transistor having a base coupled to the MS card insertion pin, a collector coupled to a high voltage source, and an emitter coupled to the target signal line.

18. The interface circuit as claimed in claim 17, wherein the target signal line is coupled to a data pin selected from the first pins and a command pin selected from the second pins.

19. The interface circuit as claimed in claim 16, wherein the card identification circuit comprises:
a PMOS transistor, having a gate coupled to the SD card insertion pin, and a source coupled to a voltage source;
a NMOS transistor, having a gate coupled to the SD card insertion pin, a source coupled to a ground, and a drain coupled to the drain of the PMOS transistor; and
a capacitor, coupled between the drain of the second NMOS transistor and the ground.

20. The interface circuit as claimed in claim 14, wherein the controller circuit determines that the secure digital card is inserted into the socket when the voltage of the signal line is high, and determines that the memory stick card is inserted into the socket when the voltage of the signal line is low.

21. A method of accessing a first-type memory card and a second-type memory card, comprising:
providing a socket capable of accepting the first-type memory card with a set of first pins or accepting the second-type memory card with a set of second pins, wherein the socket lowers the voltage of a first-type card insertion pin when the first-type memory card exists in the socket;
providing a controller circuit accessing the first-type memory card or the second-type memory card via a plurality of input/output (IO) pins; and
deploying an interface circuit between the controller circuit and the socket, wherein the interface circuit couples one of the IO pins to one of the first pins and one of the second pins, and raises the voltage of a signal line coupling to one of the IO pins when the voltage of the first-type card insertion pin is lowered to enable the controller circuit to determine which of the first-type memory card and the second-type memory card is inserted into the socket according to the voltage of the IO pin coupled to the signal line.

22. The method as claimed in claim 21, wherein the first-type memory card is a memory stick (MS) card, and the second-type memory card is a secure digital (SD) card.

23. The electronic apparatus as claimed in claim 21, wherein the socket can receive only one of the first type memory card and the second type memory card at the same time, the interface circuit raises the voltages of the second pins when the second type memory card is inserted into the socket, and the first-type memory card automatically lowers voltages of the first pins when the first type memory card is inserted into the socket.

24. The method as claimed in claim 21, wherein the interface circuit comprises a plurality of BJT transistors, having a base coupled to the first-type card insertion pin, a collector coupled to a high voltage source, and an emitter coupled to one of the IO pins.

25. The method as claimed in claim 21, wherein the controller circuit determines that the second-type memory card is inserted into the socket when the voltage of the signal line is high, and determines that the first-type memory card is inserted into the socket when the voltage of the signal line is low.
